(19) United States
(12) Patent Application Publication
(10) Pub. No.: US 2010/0304122 A1
(43) Pub. Date: Dec. 2, 2010

(54) CEMENTITIOUS SIDING HAVING ENCAPSULATED FOAM CORE, AND SYSTEM AND METHOD FOR MAKING THE SAME

(75) Inventors: John Richard Logan, Oxford, MI (US); Thomas J. Baker, Dryden, MI (US)

Correspondence Address: HOWARD & HOWARD ATTORNEYS PLLC, 450 West Fourth Street, Royal Oak, MI, 48067, US

(73) Assignee: TAPCO INTERNATIONAL CORPORATION, Wixom, MI (US)

(21) Appl. No.: 12/791,490

(22) Filed: Jun. 1, 2010

Related U.S. Application Data
(60) Provisional application No. 61/182,908, filed on Jun. 1, 2009.

(51) Int. Cl. B32B 5/18; B28B 19/00; B29C 39/10

(52) U.S. Cl. 428/317.1; 156/390; 156/245

(57) ABSTRACT

A molded siding member having an encapsulated foam core that extends substantially the entire length of the member in which it is contained, and a molding system therefor. The siding member includes a cementitious shell molded about the foam core, the shell being formed from cementitious slurry, including gypsum cement and a latex/water mixture, or hydraulic cement. After sufficient curing, the siding member is removed from the mold and is ready for immediate use and/or further processing. Also, production methods are disclosed, including a continuous method for producing relatively long lengths of the siding that can be cut to an appropriate size, without the need to produce individual siding members of limited size.

### CROSS-REFERENCE TO RELATED APPLICATION

This application claims priority to U.S. Provisional Application No. 61/182,908 filed Jun. 1, 2009, the complete disclosure of which is incorporated herein by reference.

### FIELD OF THE INVENTION

The present invention relates generally to siding systems, and more specifically to siding systems formed from cementitious slurries, especially those containing gypsum.

### BACKGROUND OF THE INVENTION

Many homes in North America use brick, vinyl siding, aluminum siding, or wood as the material comprising the exterior walls thereof. Brick provides excellent aesthetic, weather protection, and insulation properties, and is virtually maintenance free. However, brick is considerably more expensive to install than the other three primary siding materials due to the high labor costs.

Vinyl siding is made from PVC (polyvinyl chloride) and has begun to be used in construction more and more all the time. Vinyl siding can be fashioned to resemble wood, with the average width of vinyl siding ranging from 6 inches to 10 inches. However, other various lengths and widths are available. Scratches are rarely visible, because the PVC that the siding is composed of is solid all the way through. Vinyl siding is similar in many properties to aluminum, such as weight and density. However, unlike aluminum, vinyl does not dent, and besides aesthetic repair, scratched vinyl siding does not corrode and will not ruin the integrity of the siding. Temperature will not affect vinyl siding, which can be installed in nearly any climate. Aluminum siding might take a long time to re-install if damaged, which is untrue of vinyl siding. Vinyl's temperature at which it ignites is very high (736° F.), and it has half the burn time of cedar and burns one third as hard.

Aluminum siding is also one of the most popular exterior home coverings. It is more common than steel siding systems because steel tends to rust when exposed for a long period of time, unlike aluminum. Like vinyl siding, aluminum siding is relatively low-maintenance in its first few years. Aluminum siding comes in long panels, so it takes less time to install. It has baked on enamel that can be flat or shaped to resemble wood grain. Aluminum siding is waterproof, a good insulator, and the most fireproof type of siding. Unfortunately, aluminum siding is susceptible to dents and can be difficult to repair once it's been completely installed. For the first few years, aluminum siding requires little maintenance. However, it soon may show signs of cracking, corrosion, and peeling. After two or three years, the home owner should begin monitoring the aluminum siding for dents and other marks. Eventually, damaged panels should be repainted or replaced, which is a time-consuming and potentially expensive process.

The most common type of siding for a house is wood (e.g., cypress, cedar, redwood, and/or the like) which provides an attractive appearance and good insulation properties. However, as evidenced by the fact that more and more consumers are choosing vinyl, aluminum, and other siding choices, there are a number of drawbacks.

Wood in general is a haven for animals and insects. For example, many woodpeckers and other birds are drawn to the wood on the outside of houses. It is thought that tannin, a resin that is found in cedar is a natural insect repellent. However, the same tannin can cause rain spots that will appear for the first three years that the cedar is on the home. Redwood is much like cedar except that its color is slightly different.

Plywood, which is a common type of siding, is usually composed of western red fir, yellow pine, and Douglas fir. Either roughhewn or smooth, plywood is usually attached to a home horizontally and isn't the best way to protect from water damage. However, plywood is attractive for its natural look, and many ways are being developed to strengthen its structural integrity. Clapboard is simply long boards of wood applied horizontally and overlapping on a house. The result can look uneven and irregular, but beveled or tapered boards can correct this problem. Hardboard or composition board is comprised of compressed wood fiber and adhesives that are weather resistant and applied to planks or sheets of wood to strengthen them and make them more waterproof. Hardboard can measure 16 feet in length, though many people have it cut to better resemble clapboard. Plywood siding is comprised of a veneer, which is a slice of wood of constant thickness, and it is applied to hardwood to form hardwood siding. More durable than indoor plywood, it is also much more waterproof. Rectangular plank siding is comprised of smooth planks that meet each other evenly. When laid vertically, they form a flat surface that is interrupted only by battens designed to keep moisture out. Wood plank siding is very much like rectangular plank siding in that boards are laid vertically and protected from water damage. However, wood plank siding comes in many shapes and can be cut many different ways to give texture and a pattern.

A rustic, pastoral look can be achieved by using shake siding, which is made up of hand-split, irregular cedar sidings. They are rough and either put on all at once or in layers to use weathering as an effect for patterns. They are susceptible to cracking, warping and curling, so they should be checked often and replaced when necessary. Unlike shakes, sidings are machine cut, smooth and uniform. They are increasingly overlapped as they are higher on the house, however many people create their own patterns and decide the degree to which there is an overlap Like shakes, sidings can fall victim to warping, cracking, and curling.

Any wood siding product, but especially less protected wood like shakes and sidings, should be kept away from moisture and protected from the elements. Typically this involves the regular application of stains, sealants, and paints, and is generally an expensive and time-consuming process. Failure to properly maintain the wood siding product can lead to irreparable damage and potential rotting of the wood, necessitating expensive repairs.

A recent product in the siding market has been asbestos-free fiber-cement siding. Its market share is on the rise, but it still lags behind wood and vinyl siding. Fiber-cement siding generally is more expensive than aluminum or vinyl siding, but it costs less than brick or traditional cedar siding. It is sold under a number of brand names, including HARDIPLANK™, CEMPLANK™, and WEATHERBOARDS™. To make the siding, manufacturers mix cement, sand and cellulose fibers with water. The planks are offered in various widths in both horizontal and vertical styles. They can be given a smooth look or finished with a heavier wood grain appearance. James Hardie Building Products, which makes the HARDIPLANK™ line, has introduced a plank that simulates the look of sidings to use as an accent on a home. A big selling point of fiber-cement siding is that it offers a number of benefits over wood. For example, this siding resists damage from the elements and insects, and provides very good structural strength and good impact resistance. From a safety standpoint, the fiber-cement siding itself won't burn, but the finishing materials (e.g., paints) applied thereto might. On the other hand, cementitious siding contains sand or silicon dioxide (silica, SiO₂), a known respiratory hazard and eye and skin irritant. Prolonged exposure to silica dust, which may generated during the cutting and handling of cementitious siding, is best avoided unless appropriate protective precautions are taken.

Although makers of the fiber-cement siding tout its low-maintenance qualities, it does, as noted, need to be painted periodically. Attaching fiber-cement siding to a home is similar to applying wood siding; however, this type of siding is heavier, more difficult to cut, and generally more difficult to install than traditional siding materials.

Another recent development in siding products is molded reinforced cementitious siding. Such siding is comprised of cement, or a cementitious exterior shell partially enveloping an optional foam core, wherein the cementitious materials especially contain gypsum (e.g., calcined gypsum). The siding system members are formed from cementitious slurry comprising gypsum cement (e.g., calcined gypsum) and a latex/water mixture. The slurry can also contain other materials, such as but not limited to reinforcement materials (e.g., fibers, scrims, netting, meshes, and/or the like), as well as other materials that are known in the art (e.g., activators, set preventers, plasticizers, fillers, and/or the like), which can be added before and/or after the combination of the gypsum and latex/water mixture. The slurry is introduced into the mold over a previously-inserted meshed reinforcement material, such as a fiberglass mat. The slurry impregnates and envelops the mat, which adds considerable flexibility to the resulting product without it breaking, as would occur in a product formed only of the hardened slurry, even with the inclusion of aggregate reinforcement materials contained in the slurry. Even with the flexing capabilities afforded with meshed or matted reinforcement materials, such siding members can be difficult to handle in long lengths (e.g., of several feet in length), which are typically used in many siding applications where wood siding is simulated.

This is in part due to a lack of member rigidity, which is overcome in part by the inclusion of a foam core. But another factor contributing to this handling problem stems from supporting elongate cementitious members at perhaps only one or two localized positions along its length, which can impart significant bending stresses in the cementitious material, at or between the localized support location(s), where bending is greatest. The bending moment acting on a member at these high stress sites typically result from the member being supported only at or near the midpoint of its length, or being supported only at or near its opposite ends. This is particularly problematic when the planar member is supported in a substantially horizontal orientation.

Therefore, it would be advantageous to provide durable and economical siding systems, and methods for forming the same, which overcome at least one of the aforementioned problems.

### SUMMARY OF THE INVENTION

The present invention provides a siding member, and methods for forming the same, wherein the siding member includes a foam core provided with a cementitious shell substantially encapsulating it.

The foam core may be substantially rectangular in cross section normal to its longitudinal axis. The core may be optionally provided with a plurality of longitudinally-extending grooves extending from at least one, and preferably both of the opposed core faces into the thickness of the core's rectangular cross section. The grooves may be arranged in an alternating arrangement, side to side, along the width (height) of the core. During molding, cementitious slurry enters the grooves, forming in the siding member a plurality of integrally formed, longitudinally extending ribs. The ribs provide the siding member with an increased moment of inertia that helps to resist bending out of the imaginary plane defined by the member and in which the member lies when unstressed, but also provides the siding member with increased support that increases the exposed face's resistance to damage due to hammer blows during installation, by virtue of the hammer striking areas in which the siding thickness beneath the thin cementitious shell comprises a substantial amount of cementitious material rather than only foam.

The siding member may be formed in a mold from cementitious slurry comprising gypsum cement (e.g., calcined gypsum) and a latex/water mixture, or comprising hydraulic cement. The slurry can also contain other materials, such as but not limited to reinforcement materials (e.g., fibers and/or the like), as well as other materials that are known in the art (e.g., activators, set preventers, plasticizers, fillers, and/or the like), which can be added before and/or after the combination of the gypsum and latex/water mixture, or mixing of the hydraulic cement. The present invention also provides an alternative continuous method for producing relatively long lengths of the siding that can be cut to an appropriate size, without the need to produce individual siding members of limited size.

The slurry is introduced into the mold or molding system over the foam core that substantially lies in a plane and extends substantially the entire length of the siding member being formed. In cross section, normal to the siding member's longitudinal axis, one or both of the opposed exposed (front) and reverse (back) surfaces may have integrally-formed ribs extending longitudinally substantially the entire length of the siding member, thus providing the siding member with an increased moment of inertia, increasing its bending resistance, as well as additional support against hammer blows that may damage the siding surface, as discussed above.

The siding is provided with a reinforcing material fabric impregnated and encapsulated by the cementitious slurry during molding. The reinforcing material, which may be woven fiberglass, improves the siding's ability to withstand flexing and hammer blows without surface cracking or breakage, thereby improving flexural strength. The reinforcing fabric is preferably located both between the exposed, front face of the siding and the front face of the foam core, and between the reverse, rear face of the siding and the back face of the foam core.

Increased rigidity is provided by preferably coating the opposite faces of the foam core with a bonding agent prior to molding, by which the resulting cementitious shell is adhered to the core. Affixing the cementitious shell to the opposite front and back sides of the foam core allows the siding member to better resist bending by placing the opposed sides of the shell, which are located on opposite sides of the imaginary plane defined by the member, as well as the foam core in tension and compression.

Moreover, because cementitious material is displaced by the core, less of the cementitious material is used in each siding member, thereby decreasing the weight of the siding member and, depending on the materials used, its direct variable cost. This weight reduction also reduces indirect variable cost, in terms of fuel to transport the siding, and makes the siding easier to handle. Moreover, because of its increased rigidity and resistance to bending out of the imaginary plane, as well as its relatively reduced weight, the individual siding members may be handled with reduced risk of breakage due supporting it at perhaps only one or two localized positions along its length, even when being supported in a substantially horizontal orientation.

Further still, due to its reduced quantity of cementitious material, vis-á-vis a cementitious siding member of comparable dimensions, the inventive siding product contains less sand or silica, thereby reducing dust-related respiratory and irritation concerns. Indeed, the inclusion of the foam core reduces dust levels in general that are generated when cutting these siding members.

Moreover, the inventive siding members are themselves fire resistant owing to their cementitious shell. Although fire may consume a coating applied to the siding members (e.g., paint, . . . etc. . . . ), the structure of the cementitious shell itself will remain undamaged, and prevent substantial heat transfer through the siding. Although some fires may cause the foam core itself to melt, the cementitious shell that encapsulates it should maintain its original shape, and otherwise be largely unaffected.

The shape and dimensions of the siding members generally correspond to that of the foam core, the cross sections of which may be rectangular, with or without longitudinally-extending grooves, as discussed above, or tapered to a generally triangular shape. The angle between the opposed front and back sides of a tapered siding member may be in the range of approximately 5° to approximately 10°, but may, of course, be selected outside of this range. The tapered siding members have, near their upper, sharply angled edge, a cross sectional thickness that is substantially comprised entirely of cementitious material rather than foam, thereby providing the exposed surfaces of such siding members with support against damage by hammer blows, as discussed above. The siding members of triangular cross section further reduce the amount of air space between the reverse side of the siding system and the sheathing to which it is attached. Moreover, the tapered cross section provides such siding members and siding systems a visual distinction from the prior art while also providing the advantages otherwise provided by the invention.

The slurry can contain colorants dispersed therethrough, or alternatively, the mold surface that forms the exposed siding member surface can be coated with a colorant. Further, during one or more of the aforementioned stages, the mold or molding system can be vibrated and/or force/pressure applied. After an appropriate curing or drying time, the product (e.g., a molded siding member) is removed from the mold system and is ready for immediate use and/or further processing.

The present invention provides a siding system including at least one elongate member that includes molded cementitious material having opposed front and back sides that lie on opposite sides of an imaginary plane, the front side located on one side of the imaginary plane and having a front exterior face configuration, a foam core encapsulated within the cementitious material and extending substantially the entire length of the elongate member, the foam core-encapsulating cementitious material defining a shell about the foam core, the shell affixed to the foam core, and a meshed reinforcement fabric extending substantially the entire length of the elongate member and disposed between the foam core and the front side. The fabric is enveloped by cementitious material defining the shell, and the cross-sectional thickness of the shell between the foam core and the front side minimized to only the extent necessary to define the front exterior face configuration and envelope the meshed reinforcement fabric without fabric read-through in the front surface.

In certain embodiments of the siding system, a cross section taken normal to the longitudinal axis is substantially tapered. In certain such embodiments, the cross-sectional thickness of the tapered member, for a distance from its converging edge that is substantially greater than the cross-sectional thickness of the shell normal to the imaginary plane, is substantially comprised entirely of cementitious material.

In certain embodiments of the siding system, the member includes a second meshed reinforcement fabric disposed between the foam core and the back side, and enveloped by cementitious material defining the shell, the cross-sectional thickness of the shell between the foam core and the back side minimized to only the extent necessary to envelope the meshed reinforcement fabric.

Certain embodiments of the siding system further include a bonding agent applied to opposite sides of the foam core, the shell affixed to the foam core through the bonding agent. In certain such embodiments, the meshed reinforcement fabric is adhered to the foam core through the bonding agent.

The present invention also provides a molding system for forming an elongate siding member that includes a cementitious material shell encapsulating a foam core and a meshed reinforcement fabric extending substantially the entire length of the elongate member, the shell defining a molded front exterior face configuration. The system includes an elongate mold face defining the configuration of the front exterior face of the siding member, the mold face and the siding member product produced by the system coextending longitudinally in the system, a first fabric introduction system by which meshed reinforcement fabric material is oriented relative to the mold face and along the length of the mold face, a first cementitious material source from which a desired amount of cementitious material is received onto the mold face and envelops the meshed reinforcement fabric material, a foam core introduction system by which foam core is oriented relative to the mold face and along the length of the mold face, and a second cementitious material source from which a desired amount of cementitious material is received onto the foam core, whereby the foam core is encapsulated by cementitious material.

Certain embodiments of the molding system include a source of bonding agent and a bonding agent applicator adapted to apply bonding agent to opposite sides of the foam core by the applicator, the shell being affixed to the foam core through the applied bonding agent.

Certain embodiments of the molding system include a second fabric introduction system by which meshed reinforcement fabric material is oriented relative to the mold face and along the length of the mold face, the introduced foam core being disposed between fabric respectively introduced by the first and second fabric introduction systems.

In certain embodiments of the molding system, at least one of the fabric introduction system and the foam core introduction system includes a feed roller system from which a continuous length of meshed reinforcement material fabric or foam core material is respectively positioned over the mold face, and a bottom roller system including the mold face, the mold face having continuous movement in a direction corresponding to the length of the siding member product, reinforcement fabric and foam core material positioned relative to the mold face moved with cementitious material on the mold face.

In certain such embodiments, relative to the direction of mold face movement, the cementitious material source is positioned downstream of the reinforcement fabric feed roller system.

In certain such embodiments the bottom roller system comprises an endless belt on which is defined the mold face. Such embodiments may further include a top roller system comprising an endless belt having continuous movement and superposing the endless belt of the bottom roller system, the molding system having a path between the superposed belts along which siding member product is moved longitudinally through the molding system.

In certain embodiments of the molding system, the foam core introduction system includes a feed roller system from which a continuous length of foam core material is respectively received over the mold face, and an optional foam core altering station through which foam core material passes, the cross-sectional configuration of the foam core material altered in the altering station upstream of the foam core being oriented relative to the mold face. Further, in certain embodiments, the altering station receives foam core material having a substantially rectangular cross section, and produces foam core material having one of a substantially rectangular cross section, a cross section having longitudinal grooves formed therein, and a tapered or triangular cross section.

Certain embodiments of the molding system include a cutting device by which cured molded siding member product once separated from the mold face is cut to a desired length.

The present invention also provides a method of molding an elongate siding member that includes a cementitious material shell encapsulating a foam core and a meshed reinforcement fabric extending substantially the entire length of the elongate member, the shell defining a molded front exterior face configuration. The method includes the steps of: longitudinally-orienting first meshed reinforcement fabric over an elongate mold face; receiving cementitious material onto the mold face; longitudinally-orienting foam core material over the elongate mold face; receiving further cementitious material onto the foam core material and encapsulating the foam core material with cementitious material, whereby a shell of cementitious material is formed surrounding the foam core material; forming a front exterior surface of the siding member from the cementitious material received onto the mold face; curing the formed cementitious material; and separating the siding member and the mold face.

The method may include the step of longitudinally-orienting meshed reinforcement fabric over an elongate mold face is performed prior to receiving cementitious material onto the mold face, and receiving cementitious material onto the fabric and impregnating the fabric with the cementitious material.

The method may include applying a bonding agent to the opposite sides of the foam core material, and affixing the cementitious shell to the foam core through the bonding agent.

The method may include longitudinally-orienting second meshed reinforcement fabric over the foam core material.

The method may include combining the meshed reinforcement fabric and the foam core material prior to longitudinally orienting them over the mold face.

Further areas of applicability of the present invention will become apparent from the detailed description provided hereinafter. It should be understood that the detailed description and specific examples, while indicating the preferred embodiment of the invention, are intended for purposed of illustration only and are not intended to limit the scope of the invention.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is an elevational view of a dwelling having a cementitious siding system, in accordance with a first embodiment of the present invention;

FIG. 1A is a partial elevational view of a dwelling having an alternative design cementitious siding system, in accordance with a second embodiment of the present invention;

FIG. 2 is a perspective view of a cementitious siding member, in accordance with a third embodiment of the present invention;

FIG. 2A is a perspective view of an alternative design cementitious siding member, in accordance with a fourth embodiment of the present invention;

FIG. 2B is a perspective view of the cementitious siding member of FIG. 2 or 2A, showing its reverse side;

FIG. 3 is a cross sectional view of the cementitious siding system of FIG. 1 or 1A, attached to the sheathing of the building, according to a fifth embodiment of the present invention;

FIG. 3A is a cross sectional view of the cementitious siding system of FIG. 1 or 1A, attached to the sheathing of the building, according to a sixth embodiment of the present invention;

FIG. 4 is a cross-sectional view of the cementitious siding member of FIG. 2B along line 4-4 thereof, in accordance with a seventh embodiment of the present invention;

FIG. 4A is a cross-sectional view of the cementitious siding member of FIG. 2B along line 4-4 thereof, in accordance with an eighth embodiment of the present invention;

FIG. 4B is a cross-sectional view of a tapered cementitious siding member in accordance with a ninth embodiment of the present invention;

FIG. 5 is a perspective view of a portion of a molding system for forming a cementitious siding member, in accordance with a tenth embodiment of the present invention;

FIG. 5A is a perspective view of a portion of a molding system for forming an alternative design cementitious siding system, in accordance with an eleventh embodiment of the present invention;

FIG. 6 is an exploded view of a mold surface member and a mold retainer support, in accordance with a twelfth embodiment of the present invention;

FIG. 7 is a perspective view of the mold retainer support on a conveyor system, in accordance with a thirteenth embodiment of the present invention;

FIG. 8 is an exploded view of the mold surface member and the mold retainer support on the conveyor system, in accordance with a fourteenth embodiment of the present invention;

FIG. 9 is an exploded view of a first piece of reinforcement material fabric being placed into the mold surface member, in accordance with a fifteenth embodiment of the present invention;

FIG. 10 is a perspective view of cementitious slurry being introduced into the mold surface member, over and through the reinforcement material fabric placed therein, the first fabric piece being shown in ghosted lines, in accordance with a sixteenth embodiment of the present invention;

FIG. 11 is an exploded view of a foam core being placed into the mold surface member atop the previously introduced cementitious slurry, with the previously introduced first fabric piece being shown in ghosted lines, in accordance with a seventeenth embodiment of the present invention;

FIG. 12 is an exploded view of a second piece of reinforcement material fabric being placed into the mold surface member atop the previously introduced foam core, in accordance with an eighteenth embodiment of the present invention;

FIG. 13 is a perspective view of cementitious slurry being introduced into the mold surface member over and through the second fabric piece and onto the foam core, with the previously introduced second fabric piece being shown in ghosted lines, in accordance with a nineteenth embodiment of the present invention;

FIG. 14 is an exploded view of the mold surface member and mold retainer support of FIG. 8 on a conveyor system, with cementitious slurry therein and reinforcement material fabric and a foam core being placed into the mold surface member atop the previously introduced cementitious slurry, in accordance with a twentieth embodiment of the present invention;

FIG. 15 is an exploded view of the mold surface member containing a formed cementitious siding member being removed from the mold retainer support, in accordance with a twenty-first embodiment of the present invention;

FIG. 16 is an exploded view of a finished cementitious siding member being removed from the mold surface member in accordance with a twenty-second embodiment of the present invention;

FIG. 17 is a schematic view of a system for continuous production of cementitious siding members of the present invention, in accordance with a twenty-third embodiment of the present invention;

FIG. 18 is a edge-on view of a length of a cementitious siding member of the present invention, supported at the midpoint along its length and allowed to bend under its own weight; and

FIG. 19 is a edge-on view of a length of a cementitious siding member of the prior art, identical to the siding member of FIG. 18 except for excluding the encapsulated foam core, supported at the midpoint along its length and allowed to bend under its own weight.

While the invention is susceptible to various modifications and alternative forms, specific embodiments thereof are shown by way of example in the drawings and may herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE INVENTION

The following description of the preferred embodiment(s) is merely exemplary in nature and is in no way intended to limit the invention, or its uses. It is to be noted that the Figures are not drawn to scale. In particular, the scale of some of the elements of the Figures is greatly exaggerated to emphasize characteristics of the elements. It is also noted that the Figures are not drawn to the same scale. Elements shown in more than one Figure that may be similarly configured have been indicated using the same reference numerals.

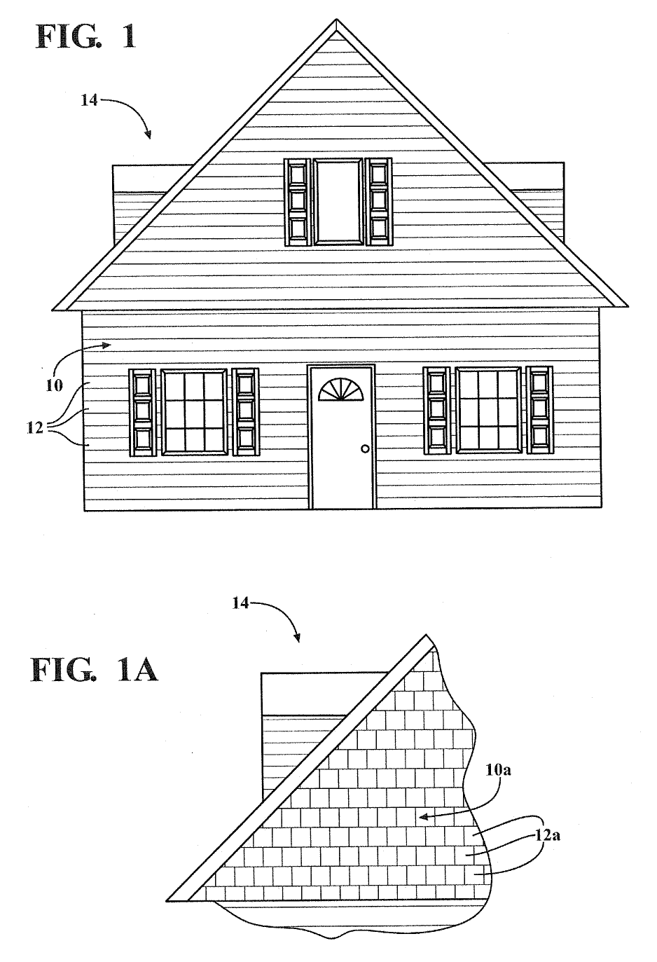

Referring to the Figures generally, and specifically to FIGS. 1 and 1A, a cementitious siding system is generally disclosed at 10 and 10a. By “system,” as that term is used herein, it is meant at least one siding member such as 12 or 12a, which may consist of one individually-formed siding member, two integrally formed siding members, and/or a plurality of integrally formed siding members, each siding member 12, 12a being substantially elongate and thereby benefiting most appreciably from the present invention. Although the present invention will be described with primary reference to siding systems or members, it should be appreciated that the present invention can be beneficially practiced with any type of elongate architectural and exterior/interior decorative element. Further, processes for the manufacture of, for example, cementitious trim members, casing members, roofing members or tiles, and other articles or systems including an encapsulated foam core, as well as such articles themselves, are intended to be within the scope of the present invention. Notably, such articles intended to be within the scope of the present invention need not be of a particular form, such as, for example, substantially planar, or even elongate, but rather may be of any configuration benefiting from advantages provided by the present invention.

The siding system 10 can be mounted, either permanently or temporarily to a dwelling, such as a residential or commercial building. FIG. 1 shows an exterior front view of a house 14. The siding system 10 is rigidly secured to the exterior walls by appropriate securing devices, such as but not limited to nails, bolts, screws, and/or the like. By way of a non-limiting example, the siding system 10 can be formed with apertures provided therein for receiving the securing devices.

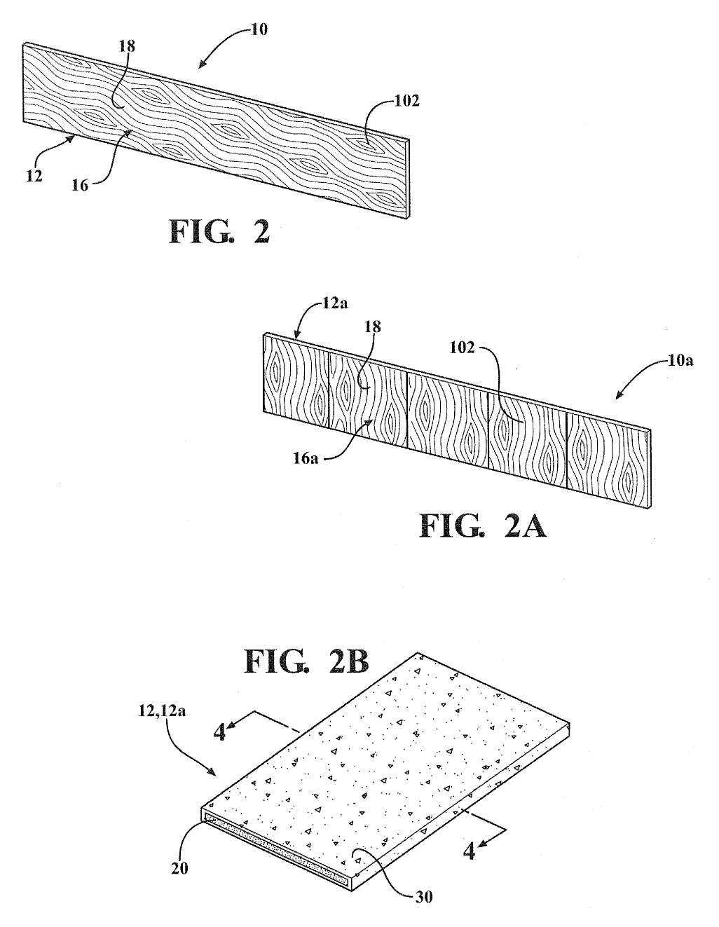

With specific reference to FIGS. 1A and 2A, an alternative design siding system 10a of the present invention can include, without limitation, a “cedar shake” or “cedar shingle” like appearance. In this view, the alternative design siding system 10a includes more than one siding member 12a, formed or placed side by side with one another.

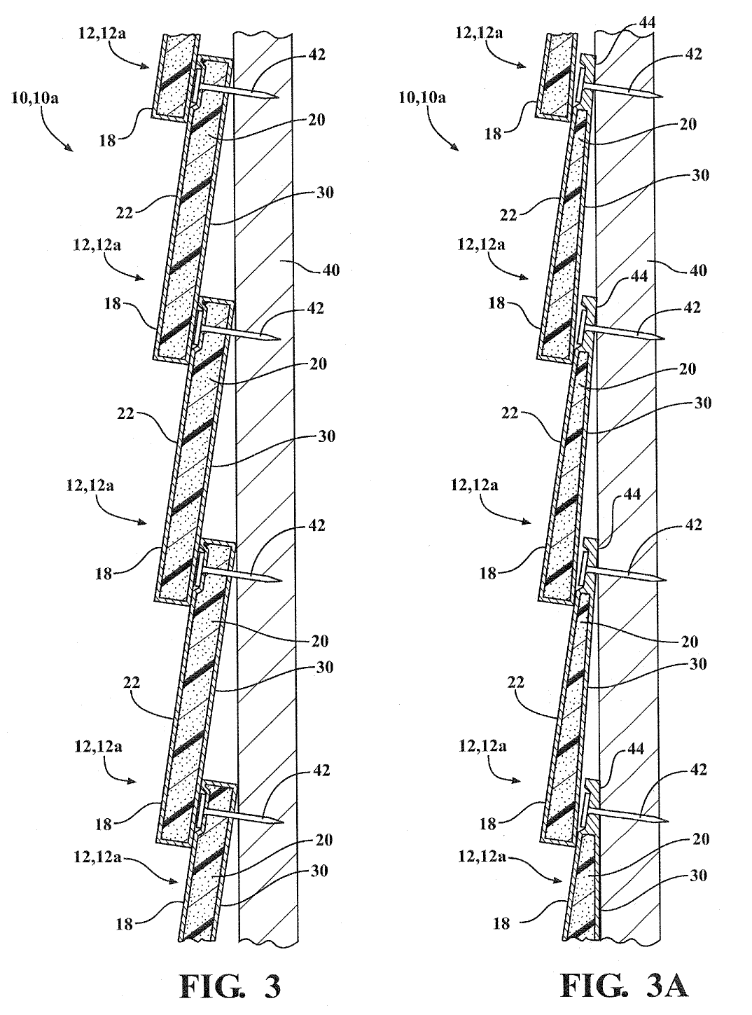

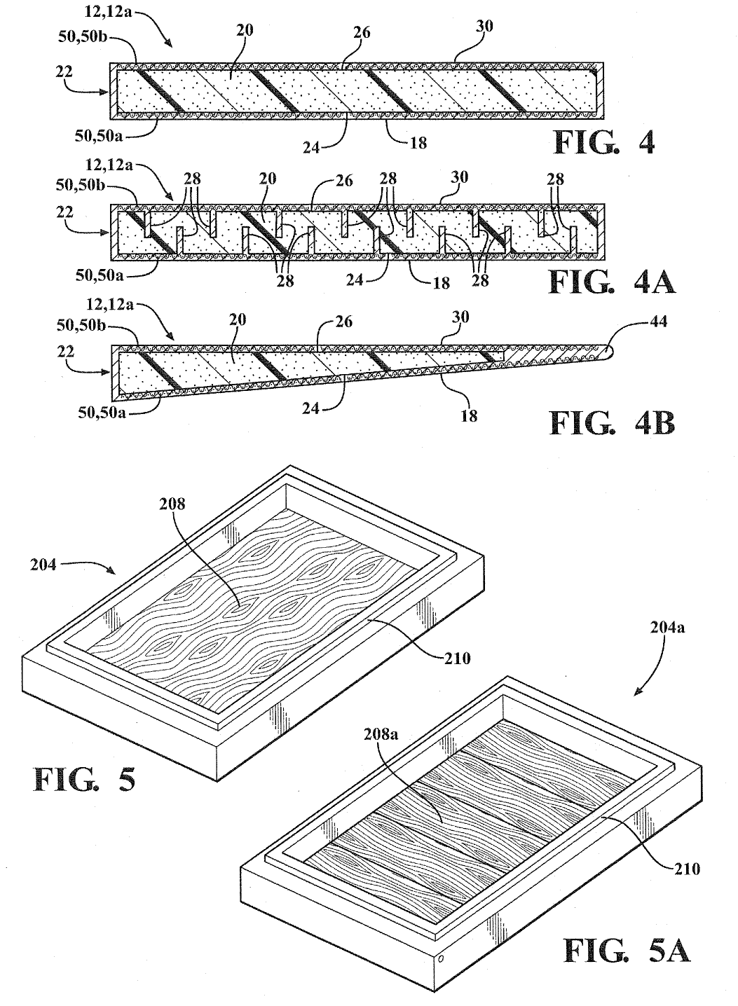

Referring to FIGS. 3 and 3A, siding members 12, 12a are shown affixed to sheathing 40 of house 14 using nails 42, in the typical manner that prior art siding members would be. FIG. 3 shows siding members 12, 12a having cross-sections taken normal to their longitudinal axes that are substantially rectangular, and FIG. 3A shows siding members 12, 12a having cross-sections taken normal to their longitudinal axes that are substantially triangular or tapered. Notably, the latter provides a reduced amount of air space between the reverse or interior sides 30 of the siding members 12, 12a (and thus of siding system 10, 10a) and the sheathing 40 to which they are attached, as well as providing a visual distinctiveness, relative to the former and to the prior art. Moreover, the cross-sectional thicknesses of the tapered siding members 12, 12a near their converging or sharply angled edges 44 are substantially comprised entirely of cementitious material rather than foam core 20, thereby providing exposed exterior surfaces 18 with support against hammer blows which might otherwise damage the exposed surface when driving nails 42. As shown in FIGS. 3A and 4B, the portion of tapered member 12, 12a that is substantially comprised entirely of cementitious material near its converging edge 44 extends from edge 44 a distance that is substantially greater than the cross-sectional thickness of shell 22 normal to the imaginary plane.

It should be appreciated that the siding members of both siding systems 10, 10a can be cut (e.g., with a circular saw, table saw, tile saw, and/or the like) to desired length, but the encapsulated foam core construction of the siding members as described below permits their installer and others to more easily handle them in long lengths (i.e., of several feet in length) with substantially reduced risk of the molded cementitious siding members breaking or cracking. As shown, siding systems 10, 10a of the present invention can include surface textures 16, 16a, respectively, on at least the exposed exterior or front face 18 of the siding member that configure the exterior face to mimic the look of wood grain or any other type of material. Additionally, the siding systems 10, 10a of the present invention can be installed in any number of patterns, e.g., the ground level can include siding system 10 and the second level or eaves can include siding system 10a.

The siding members 12, 12a include a foam core 20 encapsulated within cementitious material, the foam core extending substantially the entire member length and, generally, substantially through the siding member thickness. The foam core material may (as shown in FIG. 2B) or may not be exposed on the longitudinal ends of siding members 12, 12a. The foam core 20 may be substantially flexible, or semi-rigid, thereby facilitating the siding member's ability to be flexed to a minor degree to conform to surfaces in the ordinary manner of various siding types. That is, a certain degree of flexibility in the siding members is desirable, for example, to facilitate its installation on building sheathing.

The siding members 12, 12a include reinforcement fabric 50, such as but not limited to fibers, scrims, netting, meshes, and/or the like, added during formation or manufacture of the siding members 12, 12a, and generally referred to herein as “meshed” reinforcement material or fabric. Meshed reinforcement fabric 50 may be, for example, a loosely woven continuous strand natural fiberglass mat having a weight of approximately 0.75 ounce per square foot. First fabric piece 50a is disposed between front side 24 of foam core 20 and exposed exterior or front surface 18 of siding member 12, 12a. Preferably, siding member 12, 12a also includes second fabric piece 50b, which may be substantially identical to first fabric piece 50a, disposed between back side 26 of foam core 20 and reverse or rear surface 30 of the siding member.

The foam core 20 substantially defines the general shape and dimensions of the siding member. Referring to FIGS. 4-4B, by way of non-limiting examples, the cementitious slurry surrounds and envelopes the foam cores, shown having various cross sections, to form a thin-walled shell 22. The opposed front and rear sides of the shell 22 lie on opposite sides of an imaginary plane defined by member 12, 12a when in an unstressed condition, and out of which the member may bend under its own weight during handling. Foam core 20 is encapsulated by shell 22, which surrounds the longitudinal axis of member 12, 12a which may lie in the imaginary plane in the plane defined by the member. Meshed reinforcement material 50 (i.e., first fabric piece 50a and/or second fabric piece 50b) is contained within the molded shell 22. Vis-á-vis a comparably-dimensioned cementitious siding member, the weight of siding member 12, 12a is substantially reduced due to the cementitious material displaced from the product by the foam core 20. Additionally, the amount of sand or silica is comparatively reduced substantially, thereby providing a product that can be cut or handled more safely.

The cementitious slurry is also permitted to infiltrate through the various crevices, apertures, or spaces, if present, formed in the meshed reinforcement fabric 50, such that the meshed reinforcement fabric 50 is impregnated, and completely surrounded and enveloped by the cementitious slurry. The meshed reinforcement fabric 50 imparts increased flexural strength, fracture resistance, and/or a desired degree of flexibility to the siding members 12, 12a, and is included in each siding member 12, 12a and process embodiment depicted herein although it may not be illustrated in all views.

Foam core 20 is preferably structured or prepared to facilitate bonding between its respective, opposed front 24 and back 26 surfaces, and the cementitious slurry surrounding or encasing it. For example, a bonding agent such as, for example, commercial grade QUIKRETE™ Concrete Bonding Adhesive (Model #990214) manufactured by the Quikrete Companies, Inc., of Atlanta, Ga., (www.quikrete.com) may be applied to the opposed sides of the foam core, the bonding agent ensuring that the cementitious slurry, once cured, is affixed to the foam core. The slurry can include hydraulic cement including, but not limited to, Portland, sorrel, slag, fly ash, or calcium alumina cement. Additionally, the cement can include a calcium sulfate alpha hemihydrate or calcium sulfate beta hemihydrate. The slurry can also utilize natural, synthetic, or chemically modified beta gypsum or alpha gypsum cement.

The cementitious slurry preferably includes gypsum cement and a sufficient amount of water added thereto to produce a slurry having the desired consistency, i.e., not too dry nor not too watery. In accordance with one aspect of the present invention, the water is present in combination with a latex material, such that the powdered gypsum material is combined with the latex/water mixture to form the cementitious slurry.

Gypsum is a naturally occurring mineral, calcium sulfate dihydrate, CaSO₄.2H₂O (unless otherwise indicated, hereafter, “gypsum” will refer to the dihydrate form of calcium sulfate). After being mined, the raw gypsum is thermally processed to form a settable calcium sulfate, which can be anhydrous, but more typically is the hemihydrate, CaSO₄.1/2H₂O, e.g., calcined gypsum. For the familiar end uses, the settable calcium sulfate reacts with water to solidify by forming the dihydrate (gypsum). The hemihydrate has two recognized morphologies, alpha and beta hemihydrate. These are selected for various applications based on their physical properties. Upon hydration, alpha hemihydrate is characterized by giving rise to rectangular-sided crystals of gypsum, while beta hemihydrate is characterized by hydrating to produce needle-shaped crystals of gypsum, typically with large aspect ratio. In the present invention, either or both of the alpha or beta forms can be used, depending on the mechanical performance required. The beta form generates less dense microstructures and is preferred for low density products. Alpha hemihydrate could be substituted for beta hemihydrate to increase strength and density or they could be combined to adjust the properties.

The cementitious slurry can also include other additives. The additives can include, without limitation, accelerators and set preventers or retarders to control the setting times of the slurry. For example, appropriate amounts of set preventers or retarders can be added to the mixture to increase the shelf life of the resulting slurry so that it does not cure prematurely. When the slurry is to be used in molding operations, a suitable amount of an accelerator can be added to the slurry, either before or after the pouring operation, so as to increase the drying and/or curing rate of the slurry. Suitable accelerators include aluminum sulfate, potassium sulfate, and Terra Alba ground gypsum. Additional additives can be used to produce colored siding systems 10, 10a, such as dry powder metallic oxides such as iron and chrome oxide and pre-dispersed pigments used for coloring latex paints.

In accordance with one aspect of the present invention, the cementitious slurry includes a gypsum cement material, such as but not limited to calcined gypsum (e.g., calcium sulfate hemihydrate), also commonly referred to as plaster of Paris. One source of a suitable gypsum cement material is readily commercially available from United States Gypsum Company (Chicago, Ill.) and is sold under the brand name HYDROCAL™ FGR 95. According to the manufacturer, HYDROCAL™ FGR 95 includes more than 95 wt. % plaster of Paris and less than 5 wt. % crystalline silica.

The gypsum cement material should include an approximate 30% consistency rate. That is, for a 101b. amount of gypsum cement material, approximately 3 lbs. of water of would be needed to properly activate the gypsum cement material.

Several of the wet and/or dry components of the cementitious slurry of the present invention are readily commercially available in kit form from the United States Gypsum Company under the brand name REDI-ROCK™. Additional information regarding several suitable components of the cementitious slurry of the present invention can be found in U.S. Pat. No. 6,805,741, the entire disclosure of which is expressly incorporated herein by reference.

If a latex/water mixture is being used to create the cementitious slurry, and the mixture contains approximately 50 wt. % latex solids, then approximately 6 lbs. of the latex/water mixture would be needed. The latex/water mixture only contains approximately 50 wt. % water, the remainder being the latex solids themselves.

One or more of the dry ingredients may be combined with the liquid portion of the cementitious slurry, i.e., the latex/water mixture. If the latex/water mixture includes 50 wt. % latex solids, with the rest being water, then the latex/water mixture is present in an amount of about 60% of the weight of the gypsum cement material. For example, if 10 lbs. of gypsum cement material are used, then approximately 6 lbs. of the latex/water mixture would be used. One source of a suitable acrylic latex/water mixture is readily commercially available from Ball Consulting Ltd. of Ambridge, Pa., under the brand name FORTON™ VF-812. According to the manufacturer, FORTON™ VF-812 is a specially formulated, all acrylic co-polymer (50% solids) which cross-links with a dry resin to make the system moisture resistant and UV stable.

In accordance with another aspect of the present invention, the cementitious slurry includes a melamine resin, e.g., in the dry form, which acts as a moisture resistance agent. The melamine resin is present in an amount of about 10% of the weight of the gypsum cement material. For example, if 10 lbs. of gypsum cement material are used, then approximately 1 lb. of the melamine resin would be used. One source of a suitable melamine resin is readily commercially available from Ball Consulting Ltd. of Ambridge, Pa.

In accordance with still another aspect of the present invention, the cementitious slurry includes a pH adjuster, such as but not limited to ammonium chloride, a crystalline salt, which acts to ensure proper cross-linking of the latex/water mixture with the dry ingredients, especially the melamine resin. The ammonium chloride is present in an amount of about 1% of the weight of the gypsum cement material. For example, if 10 lbs. of gypsum cement material are used, then approximately 0.1 lbs. of the ammonium chloride would be used. One source of a suitable ammonium chloride is readily commercially available from Ball Consulting Ltd. of Ambridge, Pa.

In accordance with another aspect of the present invention, a sulfonated styrene butadiene latex emulsion such as, for example, GENCEAL™ 8100 commercially available from Omnova Solutions, Inc. of Fairlawn, Ohio (www.omnova.com), may be employed as a possibly less expensive alternative to an acrylic latex material such as FORTON™ VF-812. Notably, a sulfonated styrene butadiene latex emulsion such as GENCEAL™8100 does not require the above-mentioned use of ammonium chloride or melamine resin to achieve suitable results.

In accordance with yet another aspect of the present invention, the cementitious slurry includes a filler such as but not limited to fly ash (e.g., cenosphere fly ash), which acts to reduce the overall weight and/or density of the slurry. The fly ash is present in an amount of about 30% of the weight of the gypsum cement material. For example, if 10 lbs. of gypsum cement material are used, then approximately 3 lbs. of the fly ash would be used. One source of a suitable fly ash is readily commercially available from Trelleborg Fillite Ltd. (Runcorn, England).

The resulting cementitious slurry of the present invention should possess the following attributes: (1) it should stay wet or flowable for as long as possible, e.g., days, weeks, months, as circumstances warrant; (2) it should self level, i.e., the slurry should level by itself without intervention from the user when introduced into or onto a mold face surface; and (3) it should contain a limited water content (e.g., compared to conventional gypsum cement slurries), i.e., it should not be so wet so as to take a very long time (e.g., several hours or even days) to dry or cure.

Alternatively, the slurry can be created on demand, as needed from a water and dry components mixed therewith, avoiding the need to store a mixed volume of cementitious slurry.

Alternatively, the cementitious slurry can be a mixture of rapidly setting hydraulic cement (not a Portland cement) that may or may not contain fiberglass fillers. RAPIDSET™ Construction Cement manufactured by CTS Cement Manufacturing Corp. of Cypress, California (www.rapidset.com) is an acceptable alternative to the above-discussed gypsum/latex material, although it is somewhat more brittle and sets in a short time, necessitating its being mixed in rather small batches that can be quickly used. This hydraulic cement is, however, much cheaper than the gypsum/latex mixture, and bonds better to fiberglass.

In accordance with one aspect of the present invention, a reinforcing material can also be disposed within the cementitious slurry, either prior to or after the introduction of the water thereto. The reinforcing material can include, without limitation, fibers, e.g., either chopped or continuous fibers, comprising at least one of polypropylene fibers, polyester fibers, glass fibers, and/or aromatic polyamide fibers. By way of a non-limiting example, the reinforcing material can include a combination of the fibers, such as the polypropylene fibers and the glass fibers or the polyester fibers and the glass fibers or a blend of the polypropylene fibers and the polyester fibers and the glass fibers. If included in the fiber composition, the aromatic polyamide fibers are formed from poly-paraphenylene terephthalamide, which is a nylon-like polymer commercially available as KEVLAR™ from DuPont of Wilmington, Del. Of course, aromatic polyamide fibers other than KEVLAR™ are suitable for use in the fiber composition of the present invention.

The cementitious slurry can then be mixed, either manually or automatically, so as to adequately combine the various ingredients thereof and optionally can also be agitated, e.g., by a vibrating table, to remove or lessen any air bubbles that formed in the cementitious slurry.

Referring to FIGS. 5-16, illustrative systems and methods of forming a siding member 12, 12a of the present invention may include substantially open mold system 200. The depicted mold has a length shown as being much shorter that what may be employed in practice, for elongate member 12, 12a would normally have a length of several feet, and may have a height or width of only one foot or less.

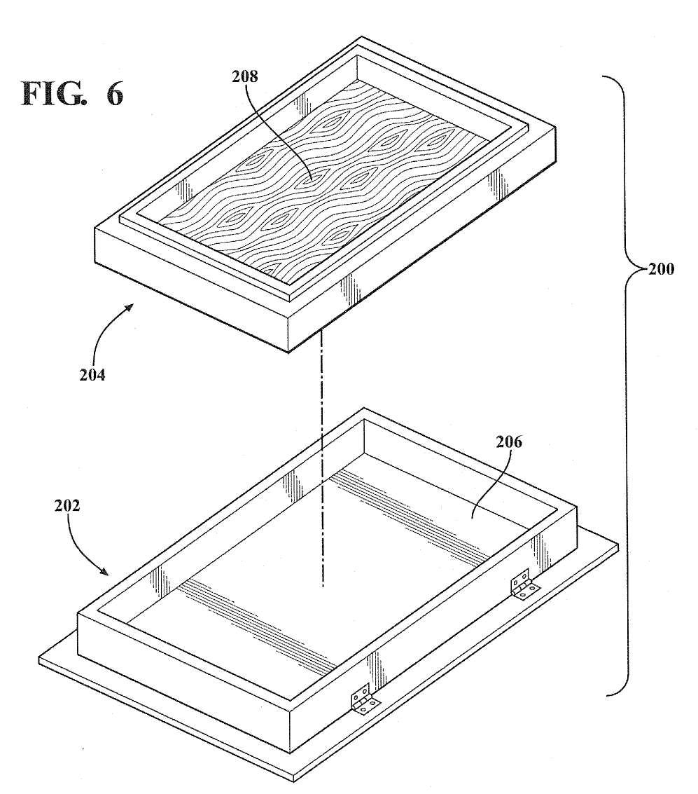

With specific reference to FIGS. 5, 5A and 6, mold system 200 may include a lower or bottom mold retainer support 202, and a mold surface member 204 preferably disposed within a cavity 206 formed in the lower or bottom lower mold retainer support 202. Although the lower or bottom lower mold retainer support 202 is shown as being an open shell having a substantially rectangular configuration, the lower or bottom lower mold retainer support 202 can have any number of various configurations.

The mold surface member 204 or 204a can be formed of any type of material, such as rigid or flexible materials; however, preferably the mold surface member 204 or 204a is formed from a suitably flexible material that, e.g., can be removed from the cavity 206 (e.g., rubber, silicone, urethane and/or the like). The respective face 208 or 208a of the mold surface member 204 or 204a is essentially a negative image of the front and/or side exterior surface configuration of the siding member 12 or 12a. Referring specifically to FIG. 5, mold surface member 204 is shown for producing siding system 10, i.e., the face 208 is essentially a negative image of the configured exterior front surface texture 16 of the siding member 12, and perhaps its side edge surface textures as well. Referring specifically to FIG. 5A, an alternative mold surface member 204a is shown for producing siding system 10a, i.e., the face 208a is essentially a negative image of the configured exterior front surface texture 16a of the siding member 12a, and perhaps its side edge surface textures as well. Additionally, the mold surface member 204 or 204a preferably includes a peripheral lip member 210 (FIGS. 5, 5A) to aid in grasping the mold surface member 204, 204a, e.g., when it is desired to remove the mold surface member from the cavity 206.

Although the following description will be directed primarily toward the production of siding member 12, it should be understood that the methodologies disclosed herein are equally applicable to the production of siding member 12a (provided that mold surface member 204a having face 208a is employed).

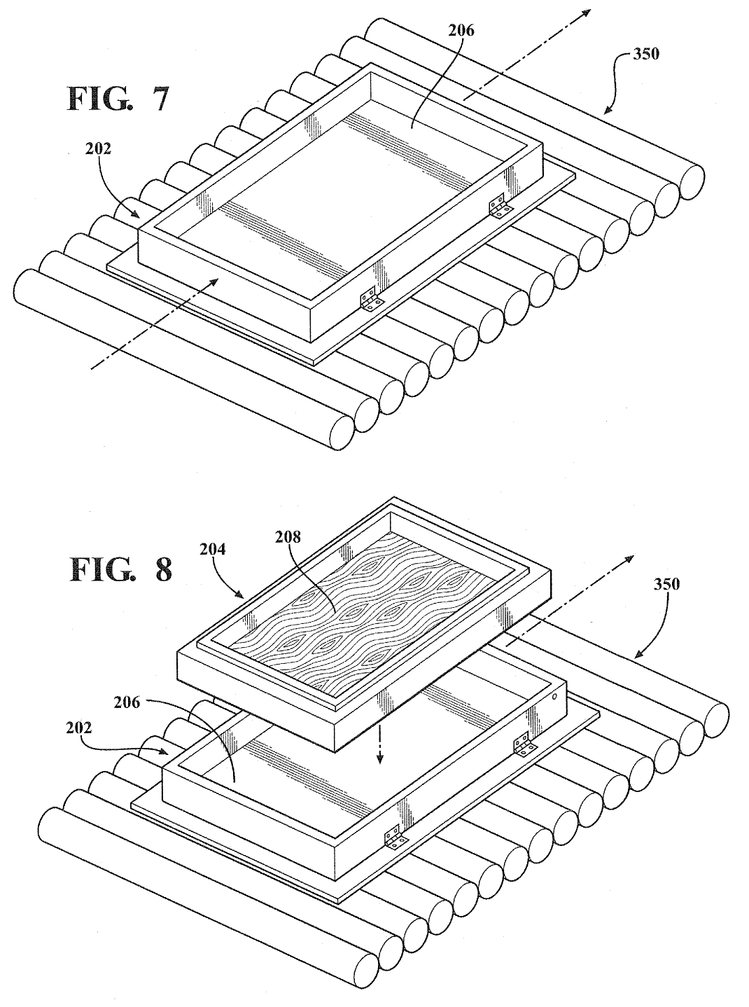

Referring specifically to FIGS. 7 and 8, because of the weights involved of the various components, as well as the cementitious slurry, a transport device, such as a conveyor system 350, either manually or automatically operated, can be employed to guide the mold system 200 along during the manufacturing process, e.g., from an initial processing station, to a curing station, and finally to a product removal station. In this manner, many siding members 12 can be produced sequentially and rapidly (e.g., in an assembly line process) without having to wait for each individual siding system to be finally and completely manufactured.

As previously noted, in order to provide siding member 12 of various colors to satisfy consumer demand, the cementitious slurry can contain colorants dispersed therethrough, or alternatively, the face 208 of the mold surface member 204 can be coated with a colorant, or in the case of a “natural cedar shake” effect, a series of colorants can be provided to produce a multi-colored and/or variegated siding member 12. Furthermore, it should be noted that paints, stains, sealants, and/or the like can also be applied to the face 208 of the mold surface member 204 before the introduction of the cementitious slurry. Alternatively, they can be applied to the finished product after removal from the mold surface member 204 in a factory setting by the siding manufacturer or at a worksite by either the installer or the homeowner.

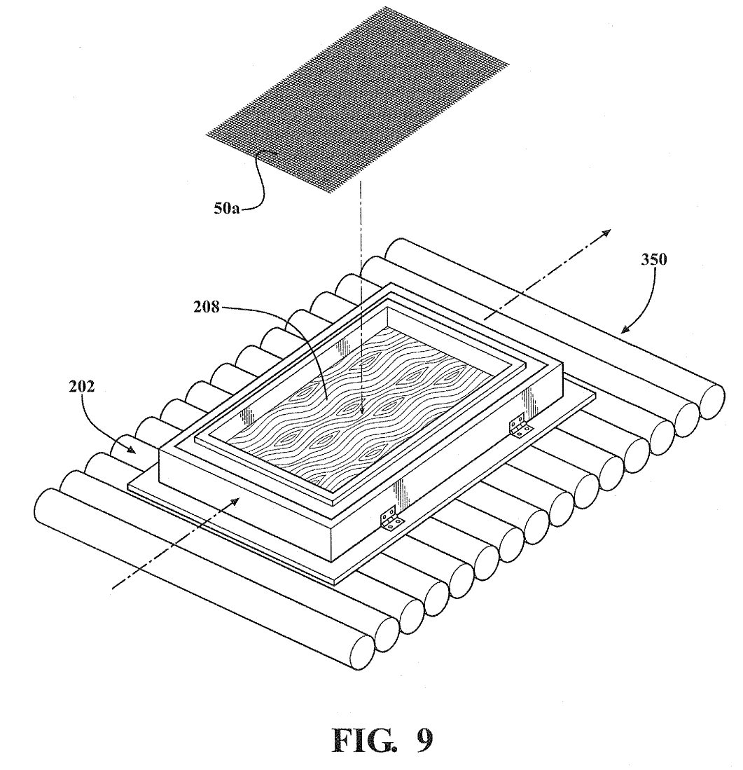

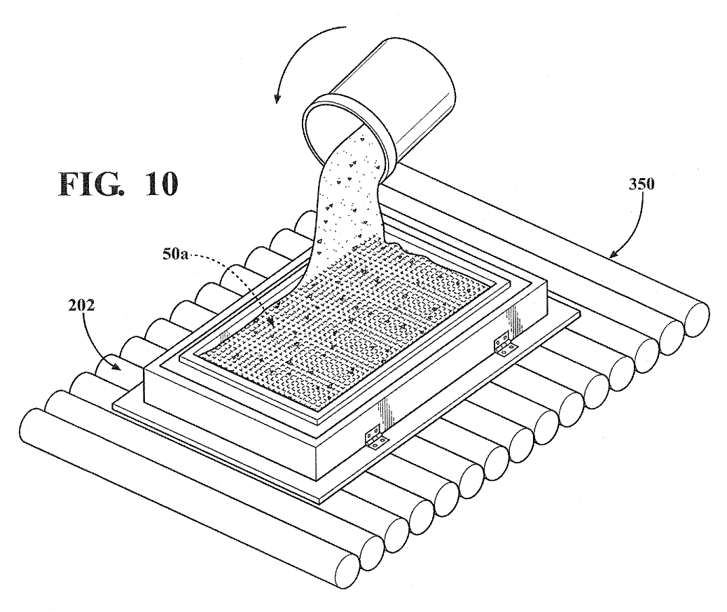

Referring specifically to the embodiments depicted in FIGS. 9-13, with mold surface member 204 having been placed in cavity 206 of support 202, first reinforcement material fabric piece 50a is placed in the mold surface member (FIG. 9), and a quantity of cementitious slurry is then introduced over and through fabric 50a (FIG. 10). It is desirable to leave a space between the meshed reinforcement fabric 50a and the face 208 of the mold surface member 204 such that the flowing cementitious slurry can fill the area therebetween and prevent any “read-through” of the meshed reinforcement fabric 50a on the finished exterior surface 18 of the siding member 12. The slurry impregnates, and surrounds and encapsulates the fibers of fabric 50a, and forms the portion of the very thin shell 22 that defines the front surface 18 of siding member 12. The thickness of this shell portion is preferably minimal—only enough to impregnate fabric 50a, and fill the surface-defining features of mold face 208 without fabric read-through in the resulting exposed siding surface 18.

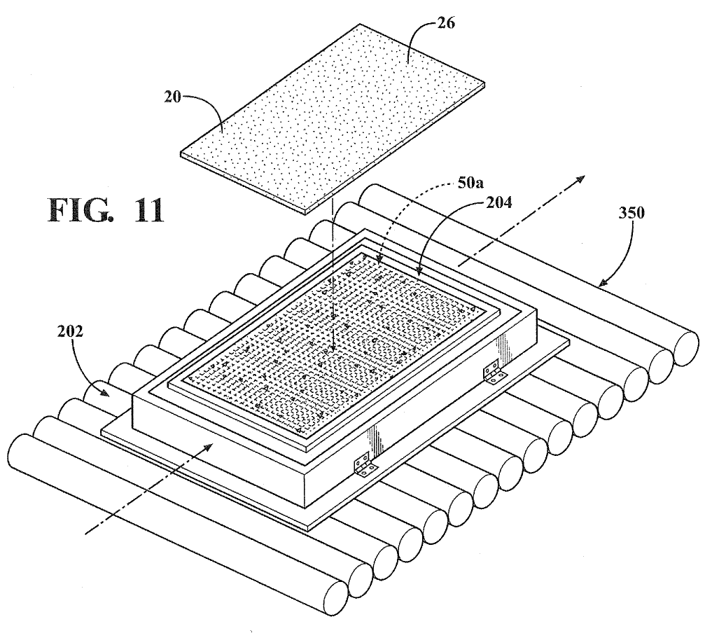

Foam core 20, of which the front (downwardly-directed) face 24 may have had a bonding agent applied thereto (e.g., by spraying, brushing or rolling), is then placed into mold surface member 204 with its front face 24 pressed into the surface of the previously introduced cementitious slurry (FIG. 11). Bonding agent may then be similarly applied to the reverse side (upwardly directed) face 26 of the foam core 20.

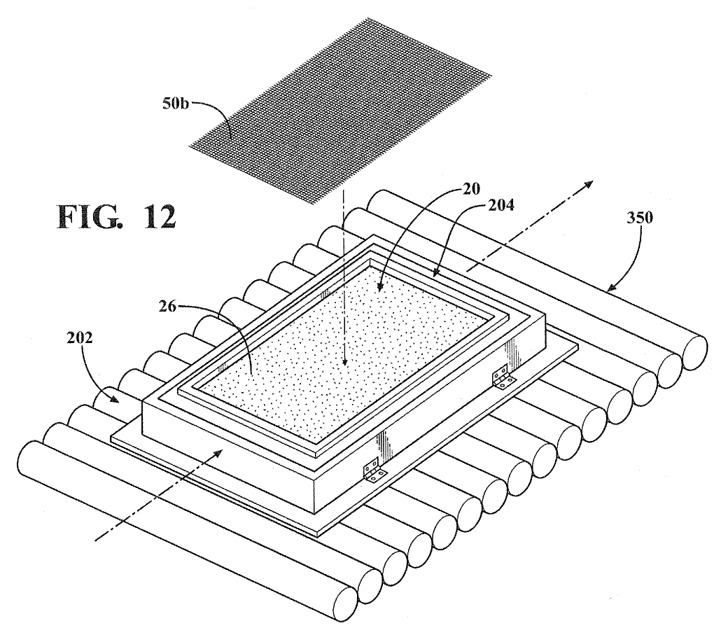

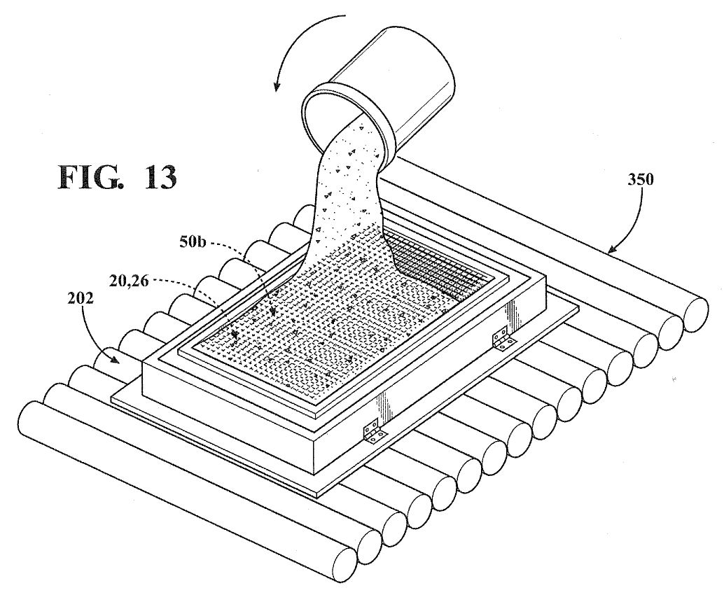

Second reinforcement material fabric piece 50b is then placed in the mold surface member 204 atop back surface 26 of previously inserted foam core 20 (FIG. 12). Cementitious slurry is then applied over and through fabric 50b and onto the back surface 26 of foam core 20 (FIG. 13), and allowed to flow over the peripheral sides of the core 20. The slurry is added to a depth that provides only a thin coating over the back 26 of the core 20, similar in thickness to that on the front face 24 of the core 20, to encapsulate fabric 50b, preferably without read-through on back or interior surface 30 of siding member 12, and to form a portion of the shell 22 that defines back or reverse surface 30 of the siding member.

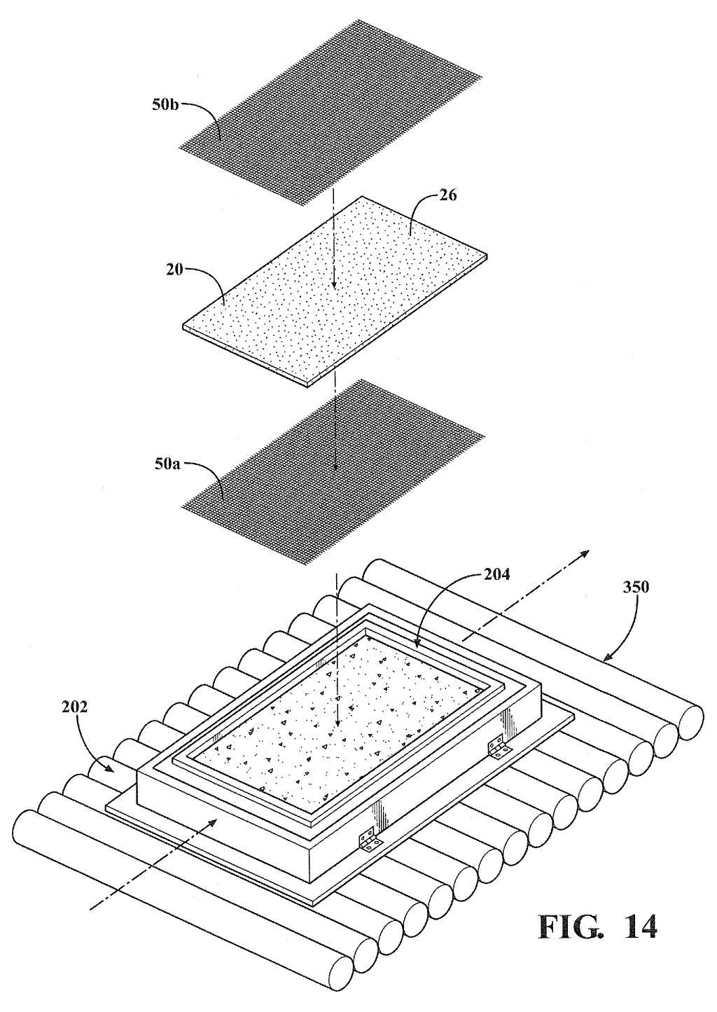

Alternatively, with specific reference to FIG. 14, with mold surface member 204 having been placed in cavity 206 of support 202, a quantity of cementitious slurry is first introduced into the mold surface member, to a depth that will form the portion of the very thin shell 22 that defines the front surface 18 of the siding member 12. Reinforcement material fabric 50a is then placed into the mold surface member and the previously introduced slurry forced into and through fabric 50a to impregnate, surround and encapsulate its fibers without fabric read-through in the exposed siding surface 18. A bonding agent is applied (e.g., by spraying, brushing or rolling) to the front (downwardly-directed) face 24 of foam core 20, and the core is then placed into mold surface member 204 with its front face 24 pressed into the surface of the cementitious slurry and/or the fabric 50a. The bonding agent is similarly applied to back surface 26 of foam core 20, and fabric 50b is then placed atop core rear surface 26. As a variation on this alternative process, bonding agent may be applied to the front 24 and back 26 surfaces of foam core 20, and fabric pieces 50a and 50b respectively positioned thereon, adhered to the foam core with the bonding agent, to form a composite that is then placed into the mold surface member 204, with fabric 50a and core front surface 24 pressed into the surface of the previously introduced cementitious slurry therein.

Then, with reference again to FIG. 13, cementitious slurry is applied over and through second reinforcement fabric piece 50b and onto the back surface 26 of foam core 20, and allowed to flow over the peripheral sides of the core. The slurry is added to a depth that encapsulates fabric 50b, preferably without read-through into siding reverse surface 30, and provides a thin coating over the back 26 of the core 20, similar in thickness to that on its front face 24, to form the portion of the shell 22 that defines back surface 30 of siding member 12.

Subsequent to the above steps, the cementitious slurry is then allowed to dry, harden or cure for a sufficient amount of time, which may depend, at least in part, on the specific composition of the cementitious slurry used. The mold system 200 can also be shuttled off of the conveyor system 350 and stored in a storage area (not shown) so that other siding members 12 can be made in the interim.

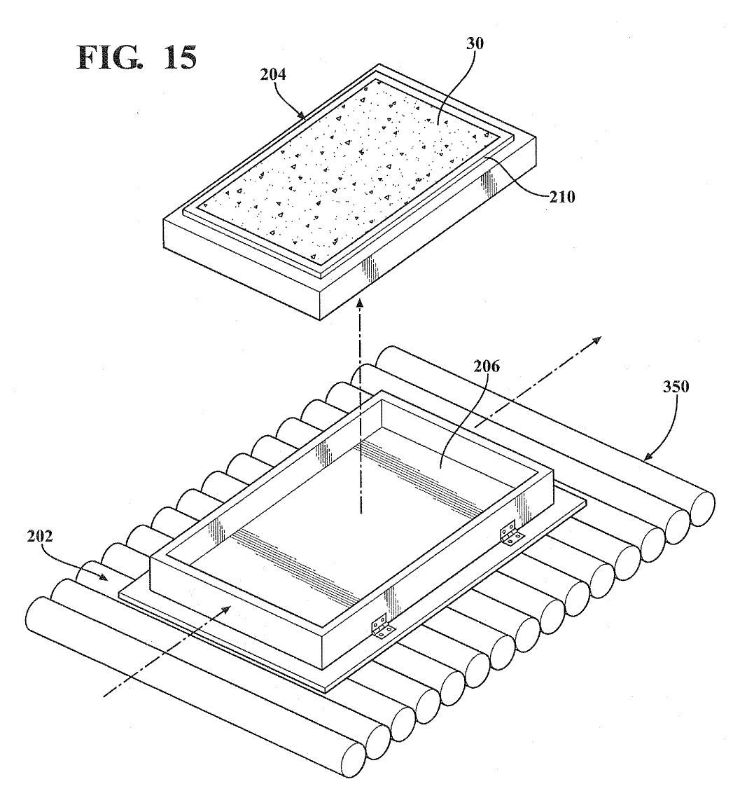

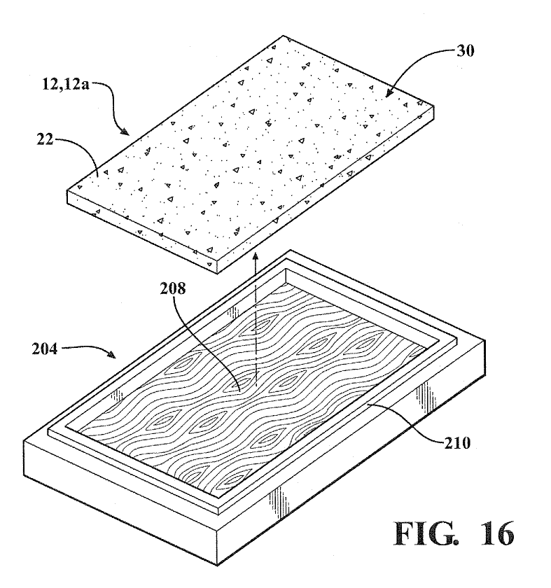

Referring specifically now to FIGS. 15 and 16, once the cementitious slurry has dried, hardened or cured, thereby forming the resulting shell 22 which encapsulates the foam core 20, the siding member 12 can then be removed from the mold system 200. For example, mold surface member 204 may be removed from the cavity 206 by grabbing the peripheral lip member 210 and lifting the mold surface member 204 upwardly and out of the cavity 206 (FIG. 15). The mold surface member 204 is then removed from the siding member 12, thus exposing the finished product (FIG. 16), which is preferably allowed to dry to a suitable extent, after which time it can then be used immediately or further processed as necessary.

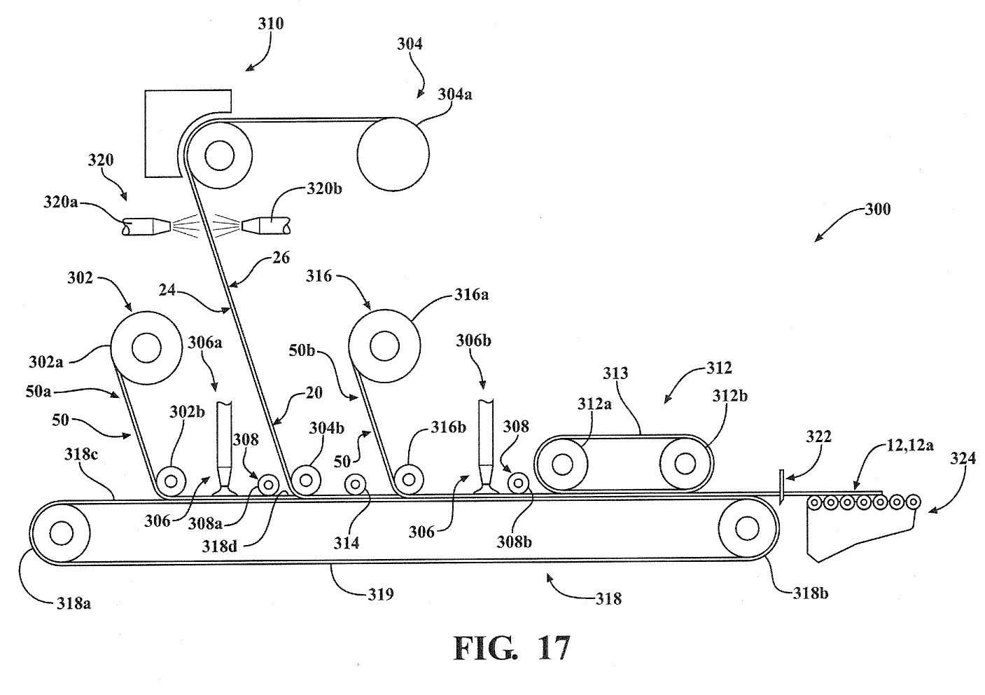

Referring now to FIG. 17, there is shown a schematic view of a system 300 for continuous production of cementitious siding members 12, 12a having a cross-section that is either substantially rectangular, as shown for example in FIG. 4, substantially rectangular and provided with longitudinally-extending grooves, as shown for example in FIG. 4A, or tapered, as shown for example in FIG. 4B. System 300 provides a continuous method for producing relatively long lengths of the siding that can be cut to an appropriate size, resulting in members 12, 12a without the need to produce individual siding members of limited size.

The system 300 primarily includes: first reinforcement material fabric feed roller system 302 (including rollers 302a and 302b); a foam core feed roller system 304 (including rollers 304a and 304b); a cementitious slurry feed system 306 (including slurry spraying nozzles 306a and 306b, which are first and second cementitious material sources, respectively); a slotted roller system 308 (including slotted rollers 308a and 308b); depending on the cross-sectional characteristics desired in the resulting siding member, an optional foam core altering station 310; a top roller system 312 (including rollers 312a and 312b, and endless belt 313 extending thereover); foam core pressing roller 314; preferably a second reinforcement material fabric feed roller system 316 (including rollers 316a and 316b); a bottom roller system 318 (including rollers 318a and 318b, and endless belt 319 extending thereover); and bonding agent feed system 320 (including bonding agent spraying nozzles 320a and 320b, which are bonding agent applicators). Reinforcement material fabric 50 may be originally provided to system 300 and the continuous molding process on rollers 302a and 316a, and foam core 20 may be originally provided to system 300 and the continuous molding process on roller 304a. In system 300, feed roller system 302 is a first fabric introduction system; feed roller system 304 is a foam core introduction system; and feed roller system 316 is a second fabric introduction system.

In the continuous molding process performed using system 300, a continuous length of the first meshed reinforcement material 50a is fed via first meshed reinforcement feed roller system 302 (including rollers 302a and 302b) onto the surface 318c of belt 319 of bottom roller system 318. An appropriate amount of the cementitious slurry is placed onto the first reinforcement material 50a via the cementitious slurry feed system nozzle 306a. Slotted roller 308a (or other appropriate roller or other device) rotates over the cementitious slurry to force the cementitious slurry to infiltrate completely through the first meshed reinforcement material 50a. Meshed reinforcement fabric 50a is impregnated, and completely surrounded and enveloped by the cementitious slurry.

A continuous length of foam core 20 may be fed via foam core feed roller system 304 (including rollers 304a and 304b) through optional altering station 310, in which foam core 20 originally having a cross-section that is uninterruptedly rectangular (as shown in FIG. 4) is altered. In station 310, foam core 20 may be machined (e.g., cut, sawed or sanded) or locally compressed, to form longitudinal grooves 28 in its opposed faces 24, 26 (as shown in FIG. 4A) or to form therefrom a tapered cross-section (as shown in FIG. 4B). Alternatively, foam core 20 may be originally provided already having the longitudinal grooves 28 formed therein or the desired tapered cross-section for molding siding 12, 12a, having the cross-sections depicted in FIGS. 4A and 4B, respectively, in which case optional altering station 310 may be omitted. Altering station 310 may also be omitted whenever originally provided foam core 20 is used without cross section modification, as, for example, when molding siding members 12 having the rectangular cross-section depicted in FIG. 4.

In its final cross sectional configuration, whether substantially rectangular (FIG. 4), substantially rectangular with longitudinal grooves (FIG. 4A), or tapered (FIG. 4B), continuous lengths of foam core 20 are preferably fed past bonding agent feed system 320 by which a bonding agent is applied to the opposed front 24 and back 26 core faces by spray nozzles 320a and 320b disposed on opposite sides of the foam core, and onto the slurry/first reinforcement fabric 50a combination located on surface 318c of bottom roller system 318. Downstream of roller 304b, foam core 20 is pressed into contact with the slurry/first reinforcement material fabric 50a combination on surface 318c by pressing roller 314.

Downstream of pressing roller 314, a continuous length of the second meshed reinforcement material 50b is fed via second meshed reinforcement feed roller system 316 (including rollers 316a and 316b) onto the back surface 26 of foam core 20, to which a bonding agent was previously applied via nozzle 320b.

Notably, fabric rollers 302a and 316a may be provided with rotational resistance to provide a desired amount of drag on reinforcement material 50 wound thereabout, and a sufficient amount of tensile stress in fabric 50 as may be required for providing a pulling force on the fabric's leading ends to take up slack and set the fabric 50 into the molding system 300. Once the molding process has begun, however, the cementitious material of the siding product exiting system 300 will have sufficiently cured to capture the fabric 50 being received into system 300, and exert the necessary pulling force on the fabric being unwound from rollers 302a and 316a to eliminate any slack in the fabric. Similarly, foam core roller 304a may be provided with rotational resistance to provide a desired amount of drag on foam core 20 wound thereabout, and a sufficient amount of tensile stress in core 20 as may be required for providing a pulling force on the core's leading end to take up slack and set the core 20 into the molding system 300. Once the molding process has begun, however, the cementitious material of the siding product exiting system 300 will have sufficiently cured to capture the core 20 being received into system 300, and exert the necessary pulling force on the core being unwound from roller 304a to eliminate any slack in the foam core.

Downstream of second reinforcement material fabric feed roller 316b, an appropriate amount of the cementitious slurry is placed over and through second reinforcement material 50b and onto core back surface 26 via cementitious slurry feed system nozzle 306b. Second slotted roller 308b (or other appropriate roller or other device) rotates over the cementitious slurry to force the cementitious slurry to infiltrate completely through the second meshed reinforcement material 50b and into contact with core back surface 26, and ensures that fabric 50b is completely encapsulated by the slurry. The cementitious slurry/reinforcement material 50a/foam core 20/reinforcement material 50b/cementitious slurry combination then travels through the top roller system 312 and bottom roller system 318, the cementitious slurry beneath the foam core 20 being pressed against textured mold face 318d formed on the surface 318c of the bottom roller system 318. The textured face 318d includes a pattern that is operable to impart the appropriate siding pattern 16, 16a onto the adjacent surface of the cementitious slurry, forming exposed exterior siding surface 18. The finished siding product then passes out through the top roller system 312 and bottom roller system 318 and can be cut by an optional cutting device 322 (e.g., a transverse saw) into siding systems of appropriate length, whereupon the cut siding members 12, 12a can be fed onto an optional conveyor system 324 for packaging or shipment purposes.

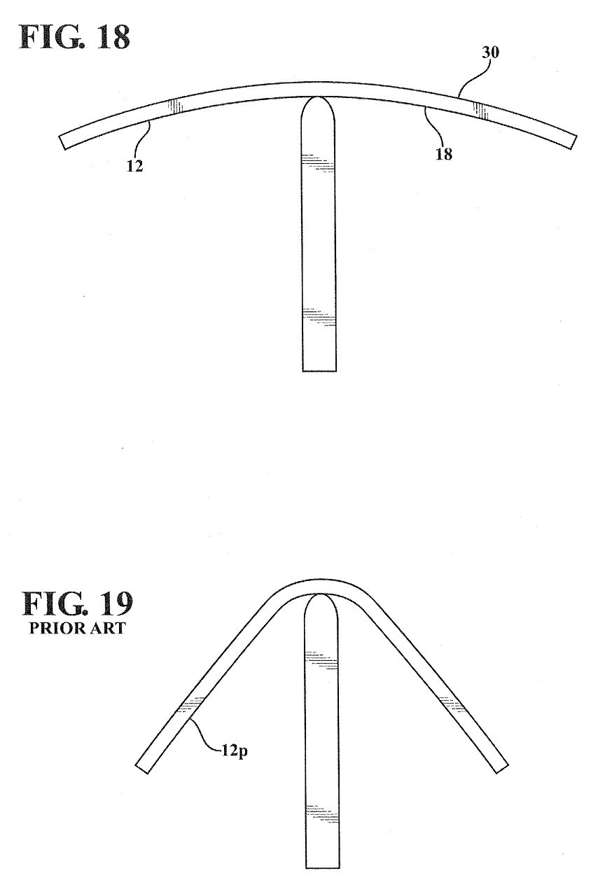

Referring to FIGS. 18 and 19, the effect on bending resistance afforded elongate siding member 12 (FIG. 18), out of an imaginary plane defined by the member and in which the member naturally lies when unstressed, by its having foam core 20 encapsulated by thin cementitious shell 22 in accordance with the present invention, vis-á-vis otherwise identical siding member 12p according to the prior art (FIG. 19), is illustrated. Each of the siding members in FIGS. 18 and 19 exhibits some degree of bending when supported solely at its longitudinal mid-point, but the degree exhibited by siding member 12 of FIG. 18 having an encapsulated foam core 20 as described above, is markedly less. This due to the weight of siding member 12 being substantially reduced by a substantial amount of cementitious material being displaced by the foam core 20. This is also due to siding member 12 better resisting bending by being supported internally by the portion of the shell 22 forming its front face 18 being in compression, and the portion of the shell 22 forming its reverse face 30 being in tension (or vice versa if the siding member 12 were supported on its opposite side), these shell portions preferably being affixed (as by bonding) to their respective opposed foam core faces 24, 26. Thus, easier handling of member 12 is facilitated, with reduced risk of its cementitious material being cracked or broken, particularly when reinforcement material 50 is included therein as described above.

While the invention has been described with reference to exemplary embodiments, it will be understood by those skilled in the art that various changes can be made and equivalents can be substituted for elements thereof without departing from the scope of the invention. In addition, many modifications can be made to adapt a particular situation or material to the teachings of the invention without departing from the essential scope thereof. Therefore, it is intended that the invention not be limited to the particular embodiments disclosed herein, but that the invention will include all embodiments falling within the scope of the appended claims.

What is claimed is:

1. A siding system comprising:
at least one elongate member comprising:
molded cementitious material having opposed front and back sides that lie on opposite sides of an imaginary plane, the front side located on one side of the imaginary plane and having a front exterior face configuration;
a foam core encapsulated within the cementitious material and extending substantially the entire length of the elongate member, the foam core-encapsulating cementitious material defining a shell about the foam core, the shell affixed to the foam core; and
a meshed reinforcement fabric extending substantially the entire length of the elongate member and disposed between the foam core and the front side, the fabric enveloped by cementitious material defining the shell, the cross-sectional thickness of the shell between the foam core and the front side minimized to only the extent necessary to define the front exterior face configuration and envelope the meshed reinforcement fabric without fabric read-through in the front surface.

2. The siding system of claim 1, wherein a cross section taken normal to the longitudinal axis is substantially tapered.

3. The siding system of claim 2, wherein the cross-sectional thickness of the tapered member, for a distance from its converging edge that is substantially greater than the cross-sectional thickness of the shell normal to the imaginary plane, is substantially comprised entirely of cementitious material.

4. The siding system of claim 1, wherein the member comprises a second meshed reinforcement fabric disposed between the foam core and the back side, and enveloped by cementitious material defining the shell, the cross-sectional thickness of the shell between the foam core and the back side minimized to only the extent necessary to envelope the meshed reinforcement fabric.

5. The siding system of claim 1, further comprising a bonding agent applied to opposite sides of the foam core, the shell affixed to the foam core through the bonding agent.

6. The siding system of claim 5, wherein the meshed reinforcement fabric is adhered to the foam core through the bonding agent.

7. A molding system for forming an elongate siding member comprising a cementitious material shell encapsulating a foam core and a meshed reinforcement fabric extending substantially the entire length of the elongate member, the shell defining a molded front exterior face configuration, the system comprising:
an elongate mold face defining the configuration of the front exterior face of the siding member, the mold face and the siding member product produced by said system coextending longitudinally in said system;
a first fabric introduction system by which meshed reinforcement fabric material is oriented relative to the mold face and along the length of the mold face;
a first cementitious material source from which a desired amount of cementitious material is received onto the mold face and at envelops the meshed reinforcement fabric material;
a foam core introduction system by which foam core is oriented relative to the mold face and along the length of the mold face; and
a second cementitious material source from which a desired amount of cementitious material is received onto the foam core, whereby the foam core is encapsulated by cementitious material.

8. The molding system of claim 7, further comprising a source of bonding agent and a bonding agent applicator adapted to apply bonding agent to opposite sides of the foam core by the applicator, the shell being affixed to the foam core through the applied bonding agent.

9. The molding system of claim 7, further comprising a second fabric introduction system by which meshed reinforcement fabric material is oriented relative to the mold face and along the length of the mold face, the introduced foam core being disposed between fabric respectively introduced by the first and second fabric introduction systems.

10. The molding system of claim 7, wherein at least one of the fabric introduction system and the foam core introduction system comprises a feed roller system from which a continuous length of meshed reinforcement material fabric or foam core material is respectively positioned over the mold face, and a bottom roller system including the mold face, the mold face having continuous movement in a direction corresponding to the length of the siding member product, reinforcement fabric and foam core material positioned relative to the mold face moved with cementitious material on the mold face.

11. The molding system of claim 10, wherein relative to the direction of mold face movement the cementitious material source is positioned downstream of the reinforcement fabric feed roller system.

12. The molding system of claim 10, wherein the bottom roller system comprises an endless belt on which is defined the mold face.

13. The molding system of claim 12, further comprising a top roller system comprising an endless belt having continuous movement and superposing the endless belt of the bottom roller system, the molding system having a path between the superposed belts along which siding member product is moved longitudinally through the molding system.

14. The molding system of claim 7, wherein the foam core introduction system comprises a feed roller system from which a continuous length of foam core material is respectively received over the mold face, and an optional foam core altering station through which foam core material passes, the cross-sectional configuration of the foam core material altered in the altering station upstream of the foam core being oriented relative to the mold face.

15. The molding system of claim 14, wherein the altering station receives foam core material having a substantially rectangular cross section, and produces foam core material having one of a substantially rectangular cross section, cross section having longitudinal grooves formed therein, and a tapered or triangular cross section.

16. The molding system of claim 7, further comprising a cutting device by which cured molded siding member product once separated from the mold face is cut to a desired length.

17. A method of molding an elongate siding member comprising a cementitious material shell encapsulating a foam core and a meshed reinforcement fabric extending substantially the entire length of the elongate member, the shell defining a molded front exterior face configuration, comprising the steps of:
longitudinally-orienting first meshed reinforcement fabric over an elongate mold face;
receiving cementitious material onto the mold face;
longitudinally-orienting foam core material over the elongate mold face;
receiving further cementitious material onto the foam core material and encapsulating the foam core material with cementitious material, whereby a shell of cementitious material is formed surrounding the foam core material;
forming a front exterior surface of the siding member from the cementitious material received onto the mold face;
curing the formed cementitious material; and
separating the siding member and the mold face.

18. The method of claim 17, wherein the step of longitudinally-orienting meshed reinforcement fabric over an elongate mold face is performed prior to receiving cementitious material onto the mold face, and further comprising:
receiving cementitious material onto the fabric and impregnating the fabric with the cementitious material.

19. The method of claim 17, further comprising:
applying a bonding agent to the opposite sides of the foam core material, and affixing the cementitious shell to the foam core through the bonding agent.

20. The method of claim 17, further comprising:
longitudinally-orienting second meshed reinforcement fabric over the foam core material.

21. The method of claim 17, further comprising:
combining the meshed reinforcement fabric and the foam core material prior to longitudinally orienting them over the mold face.
